(19) United States
(12) Patent Application Publication
(10) Pub. No.: US 2011/0180168 A1
(43) Pub. Date: Jul. 28, 2011

(54) True Union Quick-Disconnect Cam-Lock End Connector

(76) Inventor: Jon Terence Stone, Clemmons, NC (US)

(21) Appl. No.: 12/693,832

(22) Filed: Jan. 26, 2010

(51) Int. Cl. F16L 35/00; F16L 55/00

(52) U.S. Cl. 137/800; 285/88

(57) ABSTRACT

Disclosed herein is an end connector for fluid communication with a valve. The end connector includes a fitting body and a lock ring for engagement and disengagement therewith. A nut is provided for securing the fitting body to the valve, and hook and chain assembly is provided for securing an eyehole of the lock ring to an end fitting, such as a cap, which is received at an end of the connector opposite the valve. In some aspects, the fitting body includes radially extending lugs, and the lock ring includes radially extending notches corresponding to the lugs. The lock ring, in a first rotational position, is configured to abut against the lugs to inhibit inadvertent removal of the lock ring. The lock ring, in a second rotational position, is configured to have the lugs in alignment with the notches, such that the lock ring can be removed.

### FIELD OF THE DISCLOSURE

The present disclosure relates generally to improvements to an end connector, and, more particularly, to devices for inhibiting inadvertent separation of the end connector from an end fitting, such as a cap.

### BACKGROUND OF THE DISCLOSURE

It is known in the art to provide a valve for allowing and inhibiting fluid flow between two fluid paths. Such valves are provided with end connectors for facilitating quick disconnection of the flow paths and ease of replacement of the end connector. For example, reference is made to FIGS. 1 and 2, which show a prior art valve assembly 10 including a handle 12, a stem 14, and a plurality of O-rings 16 therefor. The valve assembly 10 further includes a valve body 18, a ball chamber 20, a valve seat 22, a seat retainer 24, and an O-ring 25 therefor.

The valve assembly 10 is provided with a plurality of end connectors 26a, 26b and O-Rings 28 therefor. Each one of the end connectors 26a, 26b is further provided with one of a plurality of internally threaded true-union nuts 30a, 30b for removably securing the end connectors 26a, 26b to the valve assembly 10.

End connectors such as those discussed above can be provided with a circumferentially grooved end opposite the valve assembly, and a cap (or other end fitting) can be provided for mating with the grooved end. Specifications for quick-disconnect, cam-lock fittings are provided under GSA A-A-59326B, and such specification includes requirements that the male and female connector and cap members of a coupling be provided with means for attaching a hook and chain assembly. The hook and chain assembly is used to loosely connect the male and female coupling halves for operator convenience, as well as for a safety backup, in the event that the male and female coupling halves become inadvertently disengaged. However, there are limitations on the manner in which the hook and chain assembly can be secured to the end connector by virtue of both the aforementioned GSA specifications and the standard nut configurations for a true union connection with the valve. What is needed in the art is an improved quick-disconnect end true-union connector to overcome this and/or other disadvantages of the prior art.

### SUMMARY OF THE DISCLOSURE

Disclosed herein is an improved end connector having a fitting body with a lock ring. In an end connector constructed in accordance with an exemplary embodiment of the present disclosure, the end connector is provided with a shoulder, and the lock ring abuts thereagainst, while securingly receiving a hook and chain assembly to inhibit inadvertent separation of a cap (or other end fitting) from the end connector. The end connector can be provided with a nut for securing the end connector in true union with a valve.

In some aspects, the fitting body can be provided with one or more lugs extending from a portion of the body, and the lock ring can be provided with one or more corresponding notches. In a first position, the lock ring is configured to be secured with respect to the fitting body, so as to secure a hook and chain assembly with respect to the fitting body. In a second position, the lock ring is configured to have the fitting body inserted through the lock ring, such that the lugs can pass through the notches of the lock ring during assembly and disassembly of the lock ring with the fitting body. In this regard, the lug-notch pair(s) present an example of means for selectively removing said lock ring from said body.

Preferred embodiments of the true union quick-disconnect cam-lock fitting assembly provide a user thereof with the ability to quickly replace damaged or broken end connectors without the need to replace an entire valve, pump, strainer, or other piping system component to which the fitting is attached.

Additional features, functions and benefits of the disclosed end connector shall be apparent from the detailed description which follows, particularly when read in conjunction with the accompanying figures.

### BRIEF DESCRIPTION OF THE DRAWINGS

For a more complete understanding of the present disclosure, reference is made to the following detailed description of exemplary embodiment(s) considered in conjunction with the accompanying drawings, in which:

FIG. 1 is a front perspective view showing a prior art valve having a prior art end connector;

FIG. 2 is a partially-sectioned rear perspective view taken along section line 2-2 of FIG. 1 showing the prior art valve and prior art end connector;

FIG. 3 is a front perspective view showing the prior art valve in combination with an end connector constructed in accordance with an embodiment of the present disclosure;

FIG. 4 is an assembly view showing the end connector of FIG. 3, the end connector being shown to include an elongated fitting body and a lock ring;

FIG. 5 is an exploded view showing the fitting body and the lock ring of the end connector of FIGS. 3 and 4;

FIG. 6A is a first perspective view showing the end connector shown in FIGS. 3-5 in combination with a valve, a nut, a hook and chain assembly, and a cap shown removed from the end connector; and

FIG. 6B is a second perspective view showing the end connector in combination with the valve, the nut, the hook and chain assembly, and the cap, with the cap being shown assembled with the end connector.

### DETAILED DESCRIPTION OF EXEMPLARY EMBODIMENTS

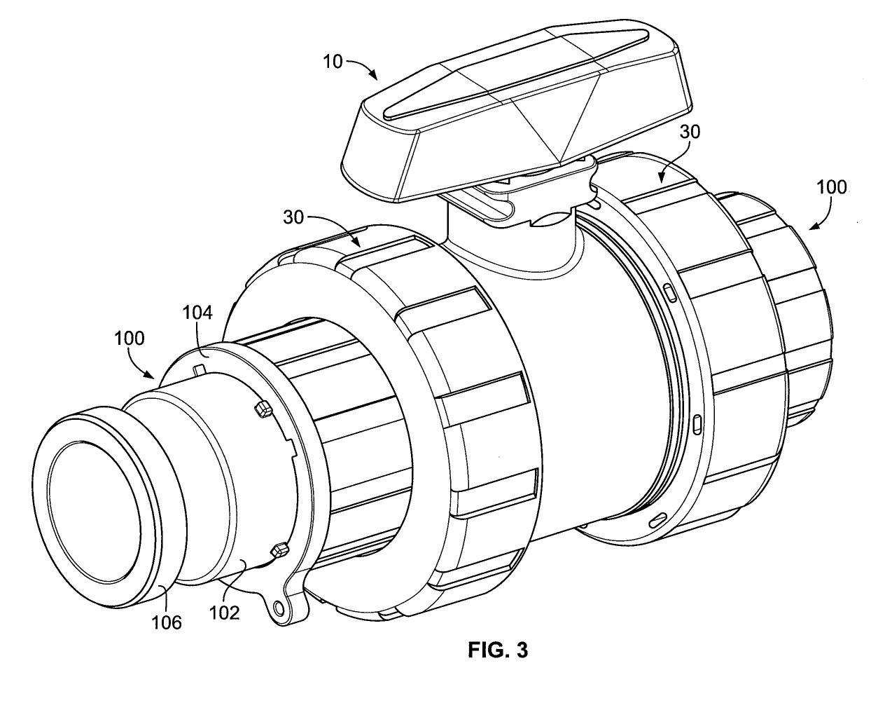

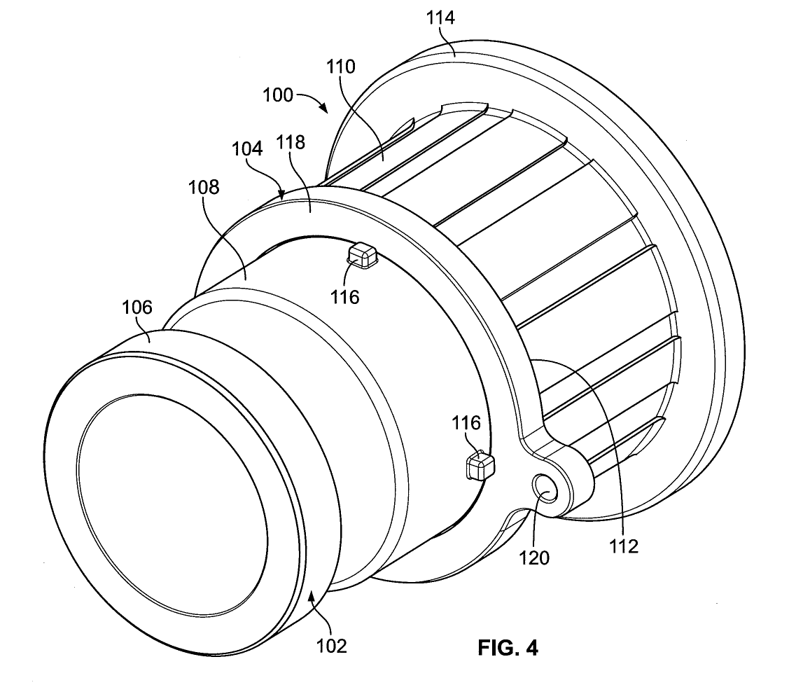

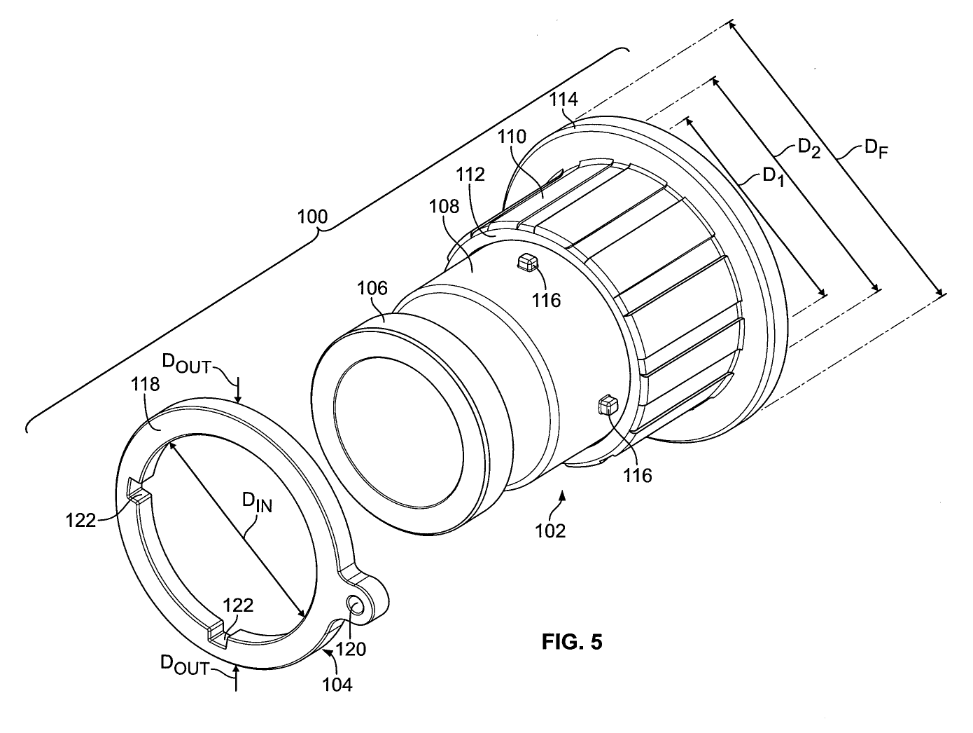

Referring to FIGS. 3-6B, an end connector 100 is shown constructed in accordance with an exemplary embodiment of the present disclosure. The end connector 100 is shown to include a fitting body 102 and a lock ring 104, which shall each be described below in turn.

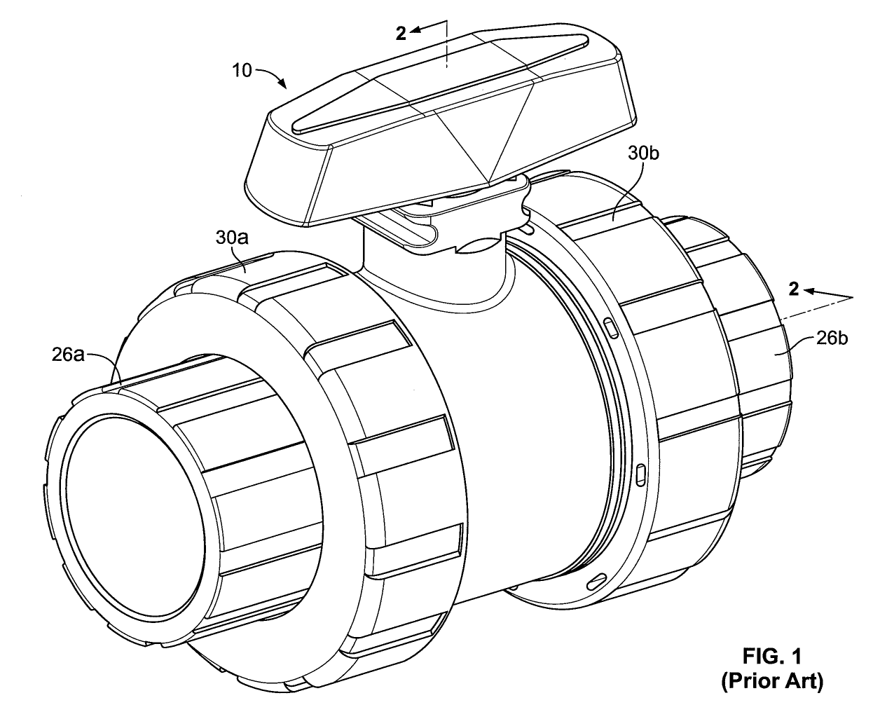

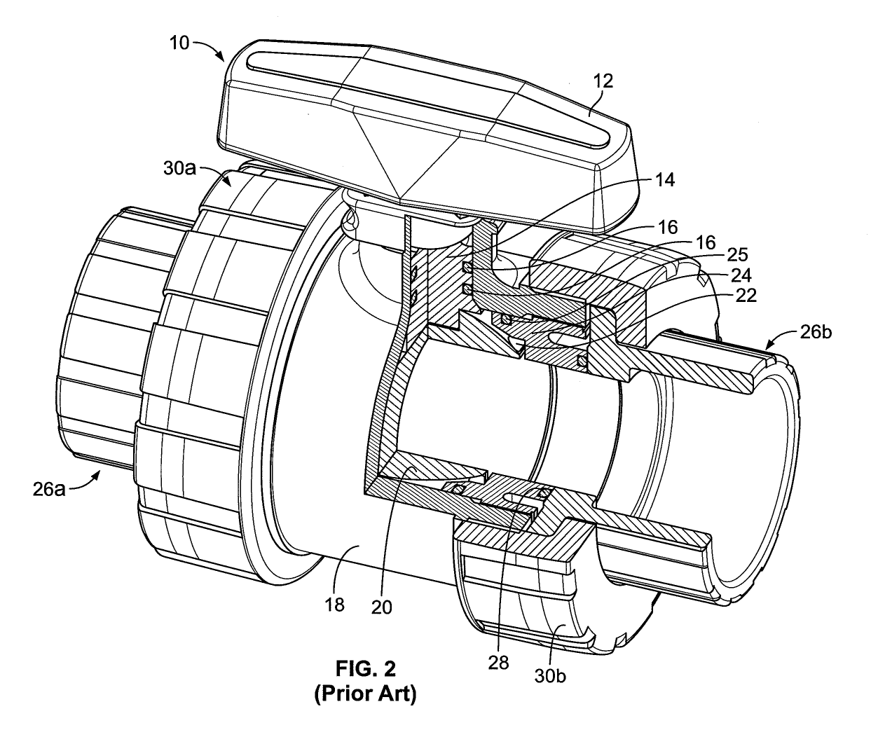

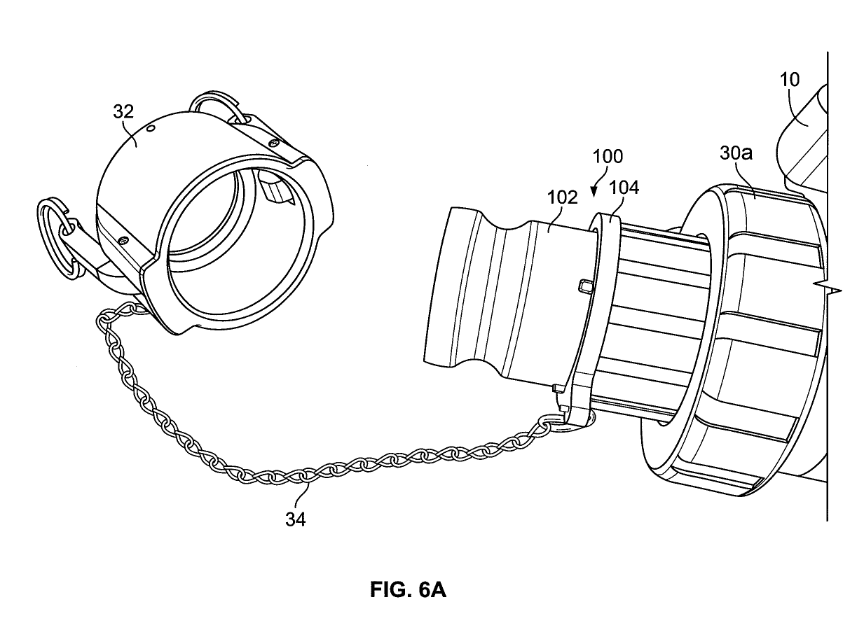

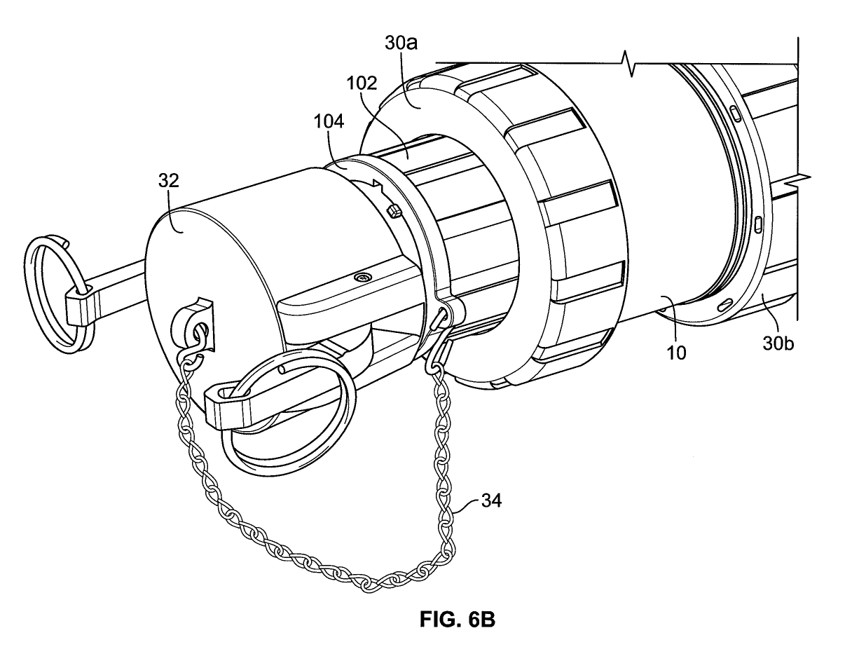

In FIG. 3, the end connector 100 of the present disclosure is shown in combination with the valve assembly 10 and nut 30 of FIGS. 1 and 2, and, in FIGS. 6A-6B, the end connector 100 of the present disclosure is shown in combination with a prior art hook and chain assembly 34 and an end fitting, such as a cap 32. It is contemplated that any suitable end fitting can be provided as an alternative to (or in addition to) the cap 32. For example, the end fitting can comprise a pipe-like coupling for fluid communication between the end connector 100 and an environmental structure, such as a conduit.

The nut 30 is used as a means for attaching the fitting body 102 of the end connector 100 to the valve assembly 10, and the hook and chain assembly 34 is used as a means for attaching the lock ring 104 of the end connector 100 to the cap 32. In preferred embodiments, the nut 30 is formed of thermoplastic materials, especially, polyvinyl chloride (PVC), chlorinated polyvinyl chloride (CPVC), and glass-filled polypropylene.

In exemplary embodiments of the present disclosure, the lock ring 104 is of particular advantage to secure the hook and chain assembly. The diameter of the fitting body 102 immediately adjacent the groove can be determined largely by the GSA A-A-59326B specification and the clearance of the nut 30 is determined largely by standards of the art, and clearance between the two diameters is not typically sufficient to accommodate a boss, for example, for the purpose of attaching hook and chain assembly 34. The lock ring 104 shall be discussed further below after further discussion of the fitting body 102.

The fitting body 102 is substantially tubular in shape with a flange portion at an end and a large rounded groove on the opposite end. The groove on the end of the body comprises the cam-lock groove, whose geometry is preferably that described by GSA A-A-59326B, the contents of which are incorporated herein by reference in their entirety for all purposes.

The fitting body 102 of FIGS. 3-6B includes a grooved end 106, a first body portion 108 adjacent, e.g., proximal, the grooved end 106, and a second body portion 110 adjacent, e.g., proximal, the first body portion 108. The first body portion 108 has a first diameter D₁ (with respect to a central longitudinally-extending axis of the end connector 100), and the second body portion 110 has a second diameter D₂ (with respect to the central axis) greater than the first diameter D₁, such that the first and second body portions 108, 110 form at a junction thereof a shoulder 112. The shoulder 112 resulting from the change in diameter on the outside of the fitting body 102 preferably occurs approximately 60% of the fitting length from the grooved end 106. As further described below, the shoulder 112 preferably forms a stop for the lock ring 104.

A flange 114 extends radially from the second body portion 110 at an end of the end connector 100 distal from the grooved end 106 thereof, and the flange 114 has a diameter D_{F} (with respect to the central axis), which is greater than each of diameter D₁ and diameter D₂. A plurality of lugs 116 extend radially from the first body portion 108, and each one of the lugs 116 is radially displaced from each adjacent one of the lugs 116. It is contemplated that an end connector can be provided with no lugs, one lug, or a plurality of lugs. For example, approximately along the middle of the length of the fitting body 102, two lugs, protrude from the outside wall of the first body portion 108. The lugs 116 are preferably substantially rectangular or semicircular in shape and can be located ninety degrees from each other on the same diametrical plane, for example. As further described herein, a purpose of the lugs 116 is to engage corresponding notches 122 in the lock ring 104 during assembly, as well as to hold the lock ring 104 in place once installed. Once installed, the lugs 116 inhibit inadvertent, e.g., accidental, disengagement of the lock ring 104 from the fitting body 102. Any number, geometry, or spacing, of the lugs 116 could be used to achieve the same result. Preferred materials of construction for the fitting body 102 are thermoplastic materials, especially, polyvinyl chloride (PVC), chlorinated polyvinyl chloride (CPVC), and glass-filled polypropylene.

The lock ring 104 can be provided as a flat annular ring with two rectangular notches located on the inner diameter of the ring and protruding perpendicularly outward toward the outside diameter. For example, a lock ring 104 of the present disclosure includes an annulus 118 having an inner diameter D_{IN} that is just greater than the first body portion diameter D₁ and that is less than the second body portion diameter D₂. In this regard, a user can assemble the lock ring 104 to the fitting body 102 by inserting the grooved end 106 though the annulus 118 until the annulus 118 of the lock ring 104 abuts the shoulder 112 of the fitting body 102. An outer diameter D_{OUT} of the lock ring 104 can be of any suitable diameter and is preferably greater than an inner diameter of the nut 30.

The lock ring 104 includes a boss 120 extending from the outside wall of the annulus 118 to form an eyehole for securingly receiving an end of the hook and chain assembly 34. The boss 120 can be provided, for example, so as to be approximately semi-circular in shape and to have a hole extending though the center thereof. In some embodiments, two or more bosses can be provided to be protruding from the outside wall of the lock ring 104, with one or more bosses allowing for attachment of support means, such as cables, wires, etc. to support the valve assembly 10.

A plurality of notches 122 are formed in the annulus 118 of the lock ring 104. The notches 122 extend approximately half the distance from the inner wall to the outer wall. The boss 120 can be formed in the lock ring 104 so as to be one-hundred-and-eighty degrees displaced from at least one of the notches 122 of the lock ring 104.

The locations of the notches 122 on the lock ring match the location of the lugs 116 on the fitting body. The notches 122 correspond to the lugs 116 formed in the fitting body 102. Continuing the example discussed above with respect to the lugs 116, the body 102 can include two lugs displaced radially from each other by about ninety degrees along the same diametrical plane, and the lock ring 104 can include two notches 122 displaced radially from each other by ninety degrees. In this regard, the notches 122 of the lock ring 104 can be rotated about the central axis into a plurality of positions with respect to the lugs 116.

In preferred embodiments, the lock ring 104 is a round, annular, flat ring, incorporating the protruding boss 120 with through-hole that provides a means for attaching the hook and chain assembly 32. In preferred embodiments, one, two, or three notches 122 are provided to be rectangular, or semi-circular in shape, and spaced to inhibit inadvertent, e.g., accidental, disengagement of the lock ring 104 from the fitting body 102, and are located to match the position of the lugs 116 on the fitting body 102 for assembly. Any number, geometry, or spacing, of the notches 122 could be used to achieve the same result.

An exemplary embodiment of assembling and disassembling the end connector 100 shall now be further described. The nut 30a is placed over the grooved end 106 of the fitting body 102, slid over the first body portion 108 and the second body portion 110 and threaded onto the end of the valve 10 (or other fitting, vessel, etc.) until the flange 114 of the fitting body 102 is tight against the valve 10. After the aforementioned assembly of the nut 30a, the lock ring 104 is placed over the grooved end 106 of the fitting body 102, slid toward the second body portion 110, and is rotated until the notches 122 in the lock ring 104 are aligned with the lugs 116 on the fitting body 102. The lock ring 104 is then moved longitudinally along the fitting body 102 with the lugs 116 passing through the notches 122 until a flat bottom surface of the lock ring 104 engages the shoulder 112 of the fitting body 102. After the lock ring 104 engages the shoulder 112 of the fitting body 102, the lock ring 104 is rotated axially approximately forty-five degrees, for example, disengaging the notches 122 of the lock ring 104 from the lugs 116 of the fitting body 102, and releasably fixing the lock ring 104 longitudinally in place (the user may repeat the process in reverse to remove the lock ring 104 from the fitting body 102). The hook and chain assembly 34 is secured to the boss 120 of the lock ring 104 and the cap 32 (or other end fitting), and the cap 32 (or other end fitting) can be mated with the grooved end 106 to be secured thereto.

The above aspects of the present disclosure have been given by way of illustrative example. While various embodiments of the disclosure have been described herein, it should be apparent, however, that various modifications, alterations and adaptations to those embodiments may occur to persons skilled in the art with the attainment of some or all of the advantages of the present disclosure. The disclosed embodiments are therefore intended to include all such modifications, alterations and adaptations without departing from the scope and spirit of the present disclosure as set forth in the appended claims.

What is claimed is:

1. A true-union quick-disconnect cam-lock end connector, comprising
an elongated body having an internal passage for fluid communication with a valve, said elongated body including a grooved end configured to mate with an end fitting, a first portion adjacent thereto having a first diameter, a second portion having a diameter greater than said first diameter and forming a shoulder with said first portion, and a flange extending radially from said second portion;
a hook and chain assembly for securing the end fitting; and
a lock ring configured to, in a first position, be secured with respect to said body and with respect to said hook and chain assembly.

2. The end connector of claim 1 in combination with a nut configured to have said second body portion extend therethough and secure said flange with a valve.

3. The combination of claim 2, wherein said nut has an inner diameter greater than said second diameter and less than an outer diameter of said flange.

4. The combination of claim 2 in further combination with the valve.

5. The end connector of claim 1 in combination with the end fitting.

6. The combination of claim 5, wherein the end fitting comprises at cap.

7. The combination of claim 5, wherein said lock ring defines an eyehole, and wherein said hook and chain assembly secures the end fitting to said lock ring at said eyehole.

8. The end connector of claim 1, wherein said lock ring is selectively removable from said body.

9. The end connector of claim 8, wherein said lock ring has an inner diameter just greater than said first diameter and less than said second diameter.

10. The end connector of claim 9, wherein an outer diameter of said lock ring is greater than an outer diameter of said flange.

11. The end connector of claim 10, wherein said lock ring is configured to, in said first position, abut against said shoulder with said first body portion extending through said lock ring.

12. The end connector of claim 10, wherein said lock ring is configured to, in a second position, have said first body portion, in use, removed from said lock ring.

13. A true union quick-disconnect cam-lock end connector, comprising
an elongated body having an internal passage for fluid communication with a valve, said elongated body including a grooved end configured to mate with an end fitting, a first portion adjacent thereto having a first diameter, a second portion having a diameter greater than said first diameter and forming a shoulder with said first portion, and a flange extending radially from said second portion;
a nut configured to have said second body portion extend therethough and configured to secure said flange with a valve;
a hook and chain assembly for securing the end fitting;
a lock ring configured to, in a first position relative to said body, be secured with respect to said body and with respect to said hook and chain assembly; and
means for selectively removing said lock ring from said body.

14. The end connector of claim 13, wherein said lock ring is configured to, in a second position relative to said body, have said first body portion, in use, removed from said lock ring.

15. The end connector of claim 14, wherein said first position relative to said body is a first rotational position relative to said body, and wherein said second position relative to said body is a second rotational position relative to said body.

16. The end connector of claim 13, wherein said means for selectively removing said lock ring from said body, comprises at least one lug extending from said body and further comprises at least one corresponding notch formed in said lock ring.

17. The end connector of claim 16, wherein said lock ring is configured to, in said first position, be secured between said shoulder and said at least one lug.

18. The end connector of claim 16, wherein said at least one lug comprises a plurality of radially-displaced lugs, and wherein said at least one corresponding notch comprises a plurality of corresponding radially-displaced notches.

19. The end connector of claim 13 in combination with the valve.

20. The end connector of claim 13 in combination with the end fitting.

21. The combination of claim 20, wherein the end fitting comprises a cap.

22. The combination of claim 20, wherein said lock ring defines an eyehole, and wherein said hook and chain assembly secures said cap to said lock ring at said eyehole.

23. The end connector of claim 13, wherein said nut has an inner diameter greater than said second diameter and less than an outer diameter of said flange.

24. The end connector of claim 13, wherein said lock ring has an inner diameter just greater than said first diameter and less than said second diameter.

25. An assembly, comprising:
a valve;
an end fitting; and
a true union quick-disconnect cam-lock end connector, said end connector further comprising:
an elongated body having an internal passage for fluid communication with a valve, said elongated body including a grooved end configured to mate with said end fitting, a first portion adjacent said grooved end and having a first diameter, a second portion having a diameter greater than said first diameter and forming a shoulder with said first portion, and a flange extending radially from said second portion, wherein said first body portion includes at least one radially extending lug;
a lock ring having at least one radially extending notch corresponding to said at least one lug and releasably secured with said body between said lug and said shoulder; and
a hook and chain assembly securing said end fitting to said lock ring; and
a nut having said second body portion extending therethough and securing said flange with said valve.

26. The assembly of claim 25, wherein said lock ring is selectively rotatable into a position with respect to said body in which said lock ring is removable from said body by passing said at least one lug through said at least one notch.

27. The assembly of claim 26, wherein said end fitting comprises a cap.
